(19) United States
(12) Patent Application Publication
(10) Pub. No.: US 2008/0303196 A1
(43) Pub. Date: Dec. 11, 2008

(54) UPPER STRUT MOUNT ASSEMBLY

(75) Inventors: Christopher Lyew, Boynton Beach, FL (US); Dario Orlando, Parkland, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Steeda Autosports, Inc., Pompano Beach, FL (US)

(21) Appl. No.: 11/758,266

(22) Filed: Jun. 5, 2007

(51) Int. Cl. B60G 11/52

(52) U.S. Cl. 267/33

(57) ABSTRACT

An upper strut mount assembly includes a cylindrical member. The cylindrical member includes a top portion, a bottom portion, and an annular portion. A bottom surface of the annular portion abuts at least a top portion of a rolling member thereby allowing the spring seat to rotate relative to at least the cylindrical member. A first resilient member includes a first annular portion and a second annular portion. A bottom surface of the first annular portion abuts a top surface of the cylindrical member annular portion. A second resilient member includes a first annular portion and a second annular portion. A bottom surface of the first annular potion abuts a top surface of the cylindrical member annular portion. An exposed surface of the second annular portion of the second resilient abuts an exposed surface of the second annular portion of the first resilient member.

### FIELD OF THE INVENTION

The present invention generally relates to the field of automotive suspension struts, and more particularly relates to an upper strut mount assembly.

### BACKGROUND OF THE INVENTION

The versatility and performance of newer muscle cars such as the FORD MUSTANG permit owners to use one vehicle for multiple purposes. Often the same vehicle used to carry groceries home from the supermarket is used for racing applications on the weekend. Owners will often modify their vehicle to make it more competitive in their chosen form of racing. One of the most modified areas of a vehicle for racing applications is the suspension.

Front suspension tuning can be one of the most critical aspects of getting a vehicle to handle properly for either street or racing applications. Unfortunately, front suspensions that are modified exclusively for racing typically will not work properly for street driving, and street suspensions typically do not work well for racing. One of the biggest challenges for a muscle car owner who races his vehicle has been to balance the vehicle for both uses.

Furthermore, modified suspensions may cause factory components to experience forces that they are not designed to handle. For example, modified suspensions that lower a car can exert additional stress and forces on upper mount assemblies that attach strut assemblies to the chassis of a vehicle. One problem with the factory upper strut mounts is that they can fail under the additional stresses and forces experienced with modified suspensions. Another problem with factory upper strut mounts is that they do not provide for camber adjustment.

One solution to overcome failing factory upper strut mounts is to use aftermarket upper strut mounts. However, current aftermarket upper can also exhibit various problems. For example, many aftermarket upper strut mounts comprise all metal parts. This can create unnecessary NVH (Noise-Vibration-Harshness) within the upper strut mount and throughout the vehicle. Excessive vibration can eventually lead to failure of the upper strut mount. In addition to failure, NVH may have a detrimental affect to ride quality. The vehicle occupants will feel the vibrations, experience a rougher ride, and hear increased noise levels. These increased levels of NVH are not uncommon to a race car, but make for an uncomfortable ride in a street vehicle.

Therefore a need exists to overcome the problems with the prior art as discussed above.

### SUMMARY OF THE INVENTION

Disclosed is an upper strut mount assembly including a cylindrical member. The cylindrical member includes a top portion, a bottom portion, and an annular portion. The bottom portion is configured to cooperate with a central bore of a spring seat. A bottom surface of the annular portion abuts at least a top portion of a rolling member thereby allowing the spring seat to rotate relative to at least the cylindrical member. A first resilient member includes a first annular portion and a second annular portion. The first annular portion has a larger diameter than the second annular portion. A bottom surface of the first annular portion abuts a top surface of the cylindrical member annular portion. An inner surface of the first resilient member circumferentially traverses an outer surface of the cylindrical member. A second resilient member includes a first annular portion and a second annular portion. The first annular portion has a larger diameter than the second annular portion. A bottom surface of the first annular potion abuts a top surface of the cylindrical member annular portion. An inner surface of the second resilient member circumferentially traverses the outer surface of the cylindrical member. An exposed surface of the second annular portion of the second resilient abuts an exposed surface of the second annular portion of the first resilient member.

One advantage of the present invention is that an upper strut mount assembly is provided that includes resilient members that reduce vibration exhibited by other upper strut mount assemblies. Another advantage is the upper strut mount assembly of the present invention reduces Noise-Vibration-Harshness. Yet another advantage of the present invention is that the upper strut mount assembly provides for camber adjustment in both the positive and negative direction.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a perspective view illustrating the front portion of a vehicle equipped with strut front suspension;

FIG. 2 is a perspective exploded view of an upper strut mount assembly and a portion of the strut tower mounting member of the vehicle illustrated in FIG. 1, according to an embodiment of the present invention;

FIG. 3 is a front perspective view of the upper strut mount assembly of FIG. 2, according to an embodiment of the present invention;

FIG. 4 is a front cross-sectional view of the upper strut mount assembly of FIG. 2, according to an embodiment of the present invention;

FIG. 5 is an angled top perspective view of the upper strut mount assembly of FIG. 2, according to an embodiment of the present invention; and

FIG. 6 is an angled cross-sectional view of the upper strut mount assembly of FIG. 2, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

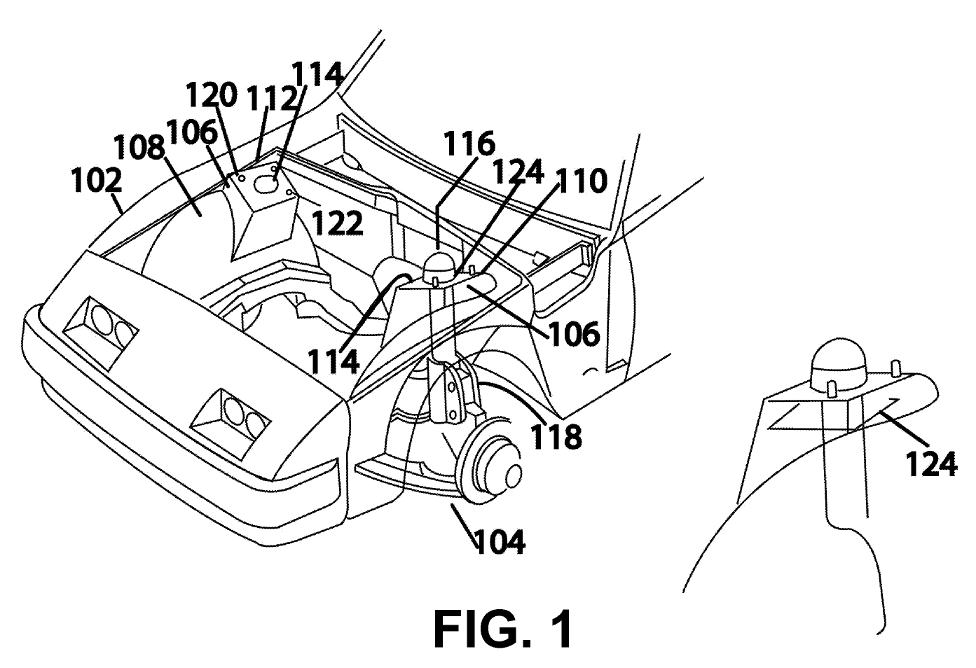

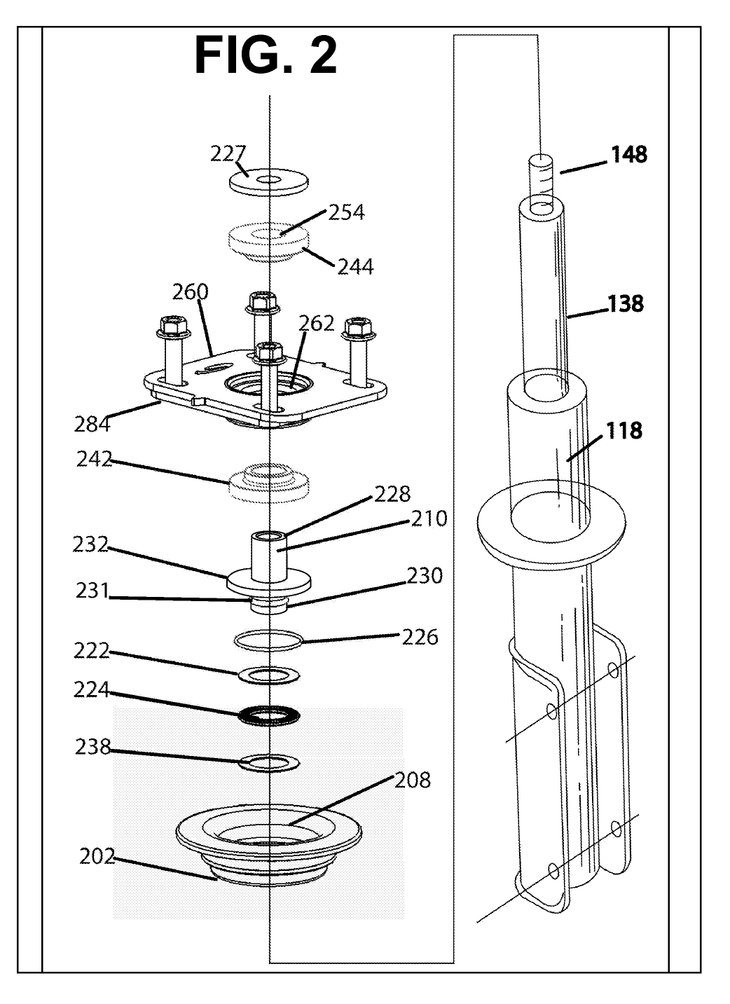

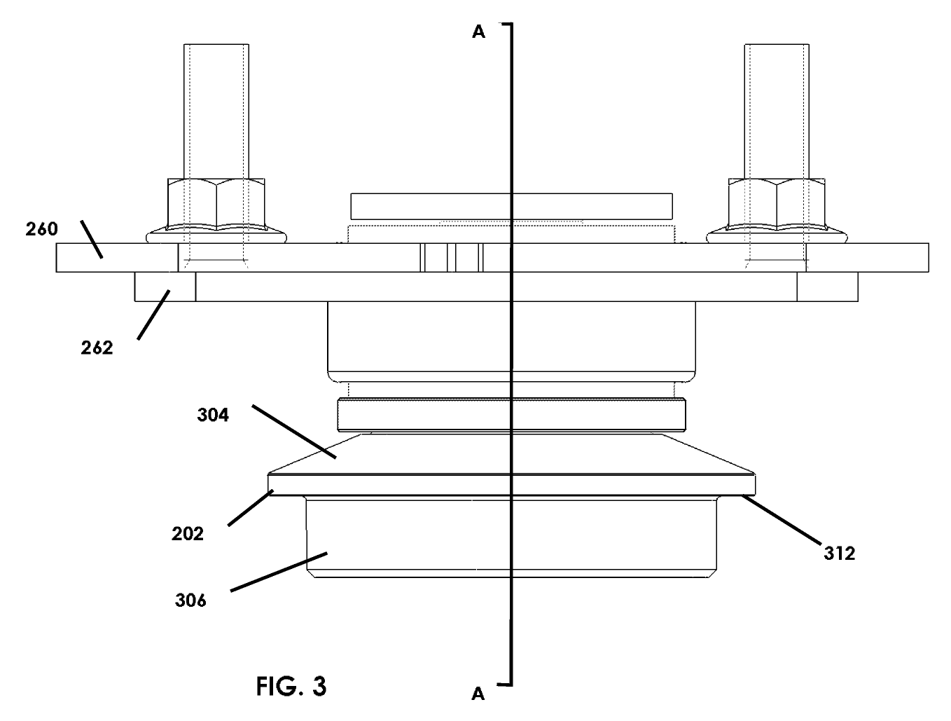

Although the invention is described in terms of a preferred specific embodiment, it will be readily apparent to those skilled in this art that various modifications, rearrangements and substitutions can be made without departing from the spirit of the invention. The scope of the invention is defined by the claims appended hereto. Referring to FIG. 1, the front portion of a vehicle 102 equipped with a strut suspension 104 is shown. The strut suspension 104 includes a pair of strut towers 106. The strut towers are typically formed from sheet metal by methods well known in the art and are secured to the inner fender wall structure 108 on both the left side 110 and right side 112 of the vehicle. Each strut tower 106 includes a mounting member 114 oriented in a plane substantially orthogonal with respect to the longitudinal axis 116 of the corresponding strut 118. A mounting member 120 generally includes a strut aperture 114 and a plurality of openings 122. The openings 122 are arranged generally parallel with respect to each other and spaced around the strut axis 116. An upper end of a strut member 118 is secured to the mounting member 118 via a stamped sheet metal member 124. It is important to note that in this original vehicle 102, the stamped sheet metal member 124 cooperates with the openings 122 but that no camber adjustment is provided. FIG. 2 shows an exploded view of an upper strut mount assembly 200 that is illustrated in conjunction with a standard strut member 118, wherein the spring member is omitted for clarity. FIGS. 3-6 illustrate various perspective views of the upper strut mount assembly 200. The upper strut mount assembly 200 replaces the stamped metal strut attachment plate 124 (FIG. 1) of the prior art. The upper strut mount assembly 200 includes a spring seat 202 comprising a conical upper portion 304 (FIG. 3) and an annular bottom portion 306 (FIG. 3). The conical upper portion 304 of the spring seat extends outwardly beyond the annular bottom portion 306, which extends in a downward fashion from the conical upper portion 304.

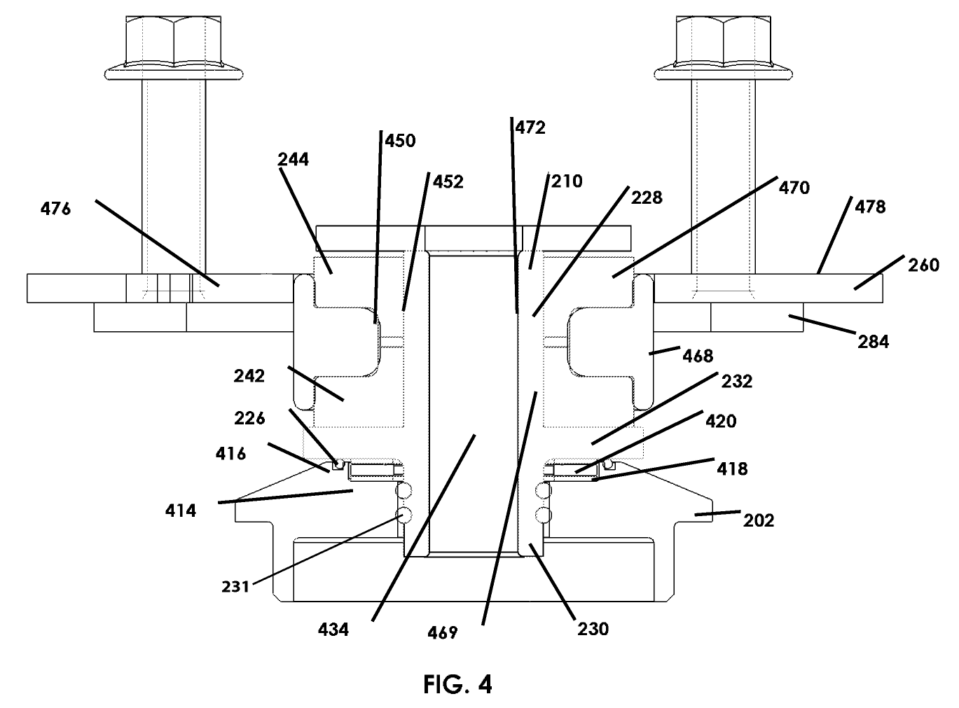

The annular bottom portion 306 of the spring seat 202 is configured so that a spring (not shown) transverses an outside diameter of the annular bottom portion 306. An underside 312 (FIG. 3) of the conical upper portion 304 abuts the spring thereby retaining the spring. The spring seat also 202 includes a central bore 208 for receiving a cylindrical member 210 such as a bushing, which is discussed in greater detail below. The spring seat 202 further includes an inner recessed area 414 (FIG. 4) that transverses an inner diameter of the spring seat 202 and an outer recessed area 416 (FIG. 4) that transverses an outer diameter of the spring seat 202. The spring seat 202, in one embodiment, is fabricated from billet aluminum. However, other metals and metal alloys such as stainless steel, titanium, brass, bronze, and the like may also be used. In one embodiment, there are two spring seat options for a kit. One option is for the OE variable diameter spring. The second option is for a constant diameter coil spring 2.5″ on the ID. Notice the difference between 306 FIGS. 3 and 202 FIG. 2.

The inner recessed area 414 of the spring seat 202, in one embodiment, houses a bearing race 418 (FIG. 4) comprising a rolling bearing 420 (FIG. 4). The bearing race/rolling bearing component 418, 420 includes a central bore 222, 224 that is aligned with and of substantially the same diameter as the central bore 208 of the spring seat 202. The roller bearing 420 allows for movement of the spring seat 202 due to rotational forces exerted by the spring. For example, as a spring is compressed the top of the spring rotates relative to the bottom of the spring. The spring can bind or make noise if the spring seat 202 is unable to rotate with the spring. Therefore, the rolling bearing 420 allows the spring seat 202 to rotate relative to upper strut mount assembly components in communication with the spring seat 202 such the cylindrical member 210.

The outer recessed area 416 is configured to embody a cushioning member 226 that provides a cushion and/or a seal between the spring seat 202 and the cylindrical member 210. The O-ring acts a cushion and/or seal. In one embodiment, the cushioning member 226 traverses the entire outer recessed area 416. The cushioning member 226, in one embodiment, is an O-ring that comprises a resilient material such as rubber. As discussed above, the upper strut mount assembly 200 includes an cylindrical member 210 such as a bushing.

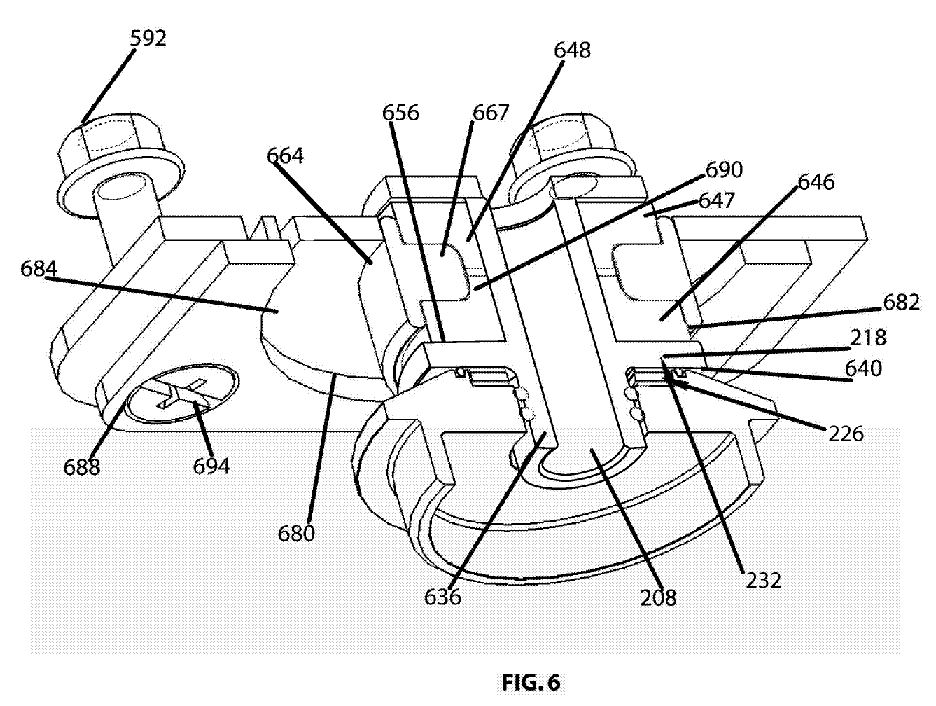

The cylindrical member 210 comprises a top portion 228, a bottom portion 230, and an annular portion 232. The cylindrical member 210 includes a central bore 434 (FIG. 4) sized to fit over the upper portion 138 of the strut member 118. The bottom portion 230 of the cylindrical member 210 is configured so that it can be inserted through the rolling bearing 420 and into the central bore 208 of the spring seat. When the cylindrical member bottom portion 230 resides within the central bore 208 of the spring seat 202 an lower bearing race 238 traverses an outer surface portion 636 (FIG. 6) of the bottom portion 230. In one embodiment, the O-ring 231 circumferentially abuts the outer surface of the cylindrical member bottom portion 230. The O-ring 231 provides a seal/cushion between the spring seat 202 and the annular member bottom portion 230.

The annular portion 232 comprises a bottom surface 640 (FIG. 6) that rests on the bearing race 418 and the cushioning member 226 when the cylindrical member bottom portion 230 resides within the central bore 208 of the spring seat 202. The upper strut mount assembly 200 also comprises a first resilient member 242 and a second resilient member 244. In one embodiment, the resilient members 242, 244 comprise urethane but can also comprise any other type of resilient materials or combination thereof. The first resilient member 242 and the second resilient member 244 are configured so that they each comprise a first annular portion 646, 647 (FIG. 6) of a first diameter and a second annular potion 648, 690 (FIG. 6) of a second diameter. In one embodiment the resilient members 242, 244 are configured in a flange configuration where the first annular portion 646 comprises a larger diameter than the second annular portion 648, 690.

Each of the resilient members 242, 244 includes a central bore 254 that allows the resilient members 242, 244 to circumferentially traverse the cylindrical member 210. An inner surface 450 (FIG. 4) of each resilient member 242, 244 contacts an outer surface 452 (FIG. 4) of the cylindrical member top portion 228. The first resilient member 242 when placed over the cylindrical member 210 rests on a top surface 656 (FIG. 6) of the annular portion 232 of the cylindrical member 210. The second resilient member 244 rests on the first resilient member 242 when placed over the cylindrical member 210. For example, FIG. 6 shows the second annular portion 648 of the second resilient member 244 resting on the second annular portion 690 of the first resilient member 244. This configuration creates an annular cavity between the first resilient member 242 and the second resilient member 244.

In one embodiment, the upper strut mount assembly 200 includes a first plate 260 such as a bushing plate that can be fabricated out of steel or any other metallic material. The first plate 260 includes a central bore 262 that allows the first plate to receive the resilient members 242, 244 and the cylindrical member 210. The first plate 260 also includes an annular portion 664 (FIG. 6) comprising an inwardly extending annular portion 667 (FIG. 6). In one embodiment, a bottom surface 468 (FIG. 4) of the inwardly extending annular portion 667 contacts a top surface 469 (FIG. 4) of the first annular portion 646 of the first resilient member 242. A top surface 470 (FIG. 4) of the inwardly extending annular portion 667 contacts a bottom surface 472 (FIG. 4) of the first annular portion 646 of the second resilient member 244. In one embodiment, a top portion 476 (FIG. 4) of the second resilient member 244 extends above a top surface 478 (FIG. 4) of the first plate 260 and a bottom portion 680 (FIG. 6) of the first resilient member 244 extends below a bottom surface 682 (FIG. 6) of first plate annular portion 664.

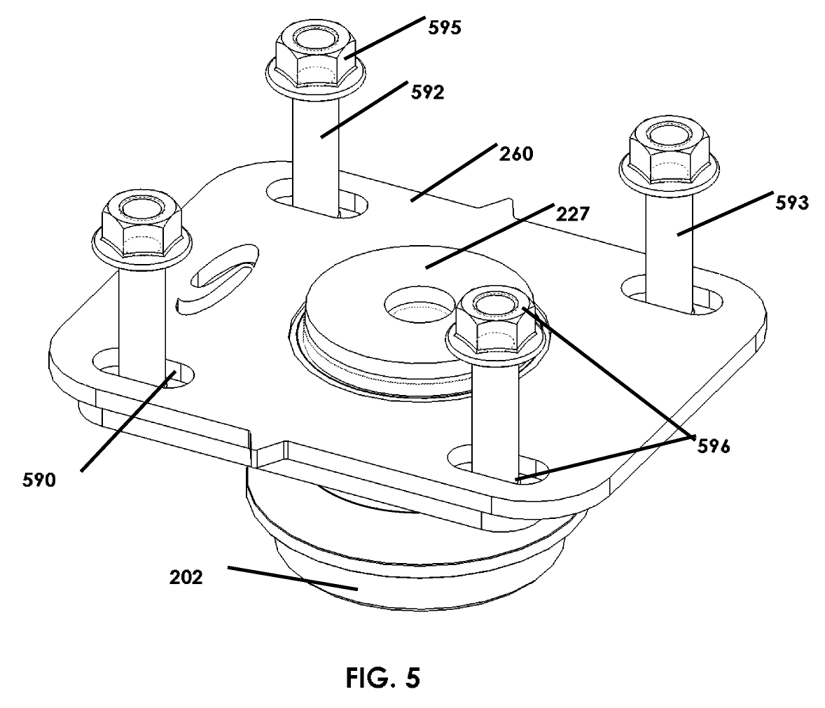

The upper strut mount assembly 200 also includes a second plate 284 (e.g., a stud plate) that is mounted on the first plate 260. The second plate 284 includes a central bore 684 (FIG. 6) for allowing various components of the upper strut mount assembly 200 such as the cylindrical member 210, the annular portion 664 of the first plate 260, and the second resilient member 244 to pass through. The second plate 284 also comprises a plurality of transverse bores 688 (FIG. 6) located toward the out edges of the second plate 284. These transverse bores 688 correspond to slots 590 (FIG. 5) situated towards the outer edges of the first plate 260. In one embodiment, the transverse bores 688 of the second plate 284 are configured to allow metal studs 592 (FIG. 5) to pass through the bores 688 while a head portion 694 (FIG. 6) of the studs 592 are retained by the bore 688. The studs pass through the plate 284 and are mechanically coupled, e.g., welded, onto the plate. In other words, the heads 694 of the metal studs 592 cannot pass through the transverse bores 688. The body portion 596 (FIG. 5) of the metal studs 592 also pass through the corresponding slots 590 in the first plate 260. The second plate 284 clamps the first plate 260 to the strut tower 160.

In one embodiment, each of the metal studs 592 includes a threaded portion 593 (FIG. 5) for receiving a threaded nut 595 (FIG. 5). Therefore as the metal studs 592 extend through the mounting member 114 of the vehicle's strut tower 106, the upper strut mount assembly 200 can be secured to the strut tower 106 by tightening the threaded nut 595 on to the metal studs 592. The upper portion 138 of the strut 118 is secured to the upper strut mount assembly 200 and the vehicle strut tower 106 by inserting the upper portion 138 of the strut 118 through the spring seat 202 and through the cylindrical member 210. A threaded portion 148 of the strut 118 extends out of the upper strut mount assembly 200 where a threaded nut can be tightened onto the threaded portion. The threaded nut comes into contact with an annular member 227 such as a washer thereby securing the strut 118 to the upper strut mount assembly 200.

It should be noted that the plurality of slots 590 in the first plate 260 also allow for camber adjustment in both the positive and negative directions. Camber is the angle at which the top of the tire is tilted inwardly or outwardly, as viewed from the front of the car. If the top of the tires lean toward the center of the car you have negative camber. If the top of the tires are tilted outward you have positive camber. Typically, as the tires are turned left and right, the camber changes slightly because the pivoting points for the tires are not vertical as viewed from the side. Adjusting camber can have a dramatic affect on the cornering characteristics of a vehicle. For example, an oval track racer will often race with negative camber on the right side of the vehicle and positive camber on the left side of the vehicle. A drag racer will often race with neutral or slightly negative camber on both sides of the vehicle and a street vehicle will typically have camber set at zero or perpendicular to the street surface.

Non-Limiting Examples

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. An upper strut mount assembly comprising:
a cylindrical member including a top portion, a bottom portion, and an annular portion, wherein the bottom portion is configured to cooperate with a central bore of a spring seat, and wherein a bottom surface of the annular portion abuts at least a top portion of a rolling member thereby allowing the spring seat to rotate relative to at least the cylindrical member;
a first resilient member comprising a first annular portion and a second annular portion, the first annular portion having a larger diameter than the second annular portion, wherein a bottom surface of the first annular portion abuts a top surface of the cylindrical member annular portion, and wherein an inner surface of the first resilient member circumferentially traverses an outer surface of the cylindrical member; and
a second resilient member comprising a first annular portion and a second annular portion, the first annular portion having a larger diameter than the second annular portion, wherein a bottom surface of the first annular potion abuts a top surface of the cylindrical member annular portion, wherein an inner surface of the second resilient member circumferentially traverses the outer surface of the cylindrical member, and wherein an exposed surface of the second annular portion of the second resilient abuts an exposed surface of the second annular portion of the first resilient member.

2. The upper strut mount assembly of claim 1, wherein the spring seat comprises a conical upper portion, an annular bottom portion, an inner recessed area, an outer recessed area, and the central bore.

3. The upper strut mount assembly of claim 2, wherein the rolling member is situated within the inner recessed area, and wherein the rolling member circumferentially traverses the inner recessed area.

4. The upper strut mount assembly of claim 2, wherein the outer recessed area includes a cushioning member that circumferentially traverses the outer recessed area, and wherein the cushioning member contacts the bottom surface of the annular portion of the cylindrical member.

5. The upper strut mount assembly of claim 4, wherein the cushioning member is an O-ring.

6. The upper strut mount assembly of claim 1, further comprising:
a first plate comprising a plurality of slots, a central bore, and an annular portion comprising an inwardly extending annular portion, wherein an upper surface of the inwardly extending annular portion abuts a bottom surface of the second resilient member first annular portion and an bottom surface of the inwardly extending annular portion abuts a top surface of the first resilient member first annular portion, and wherein the central bore of the first plate is configured to cooperate with the first resilient member, the second resilient member, and the cylindrical member.

7. The upper strut mount assembly of claim 6, wherein the first plate comprises steel

8. The upper strut mount assembly of claim 6, further comprising:
a second plate coupled to a bottom surface of the first plate, wherein the second plate includes a central bore configured to cooperate with the second resilient member and the annular member of the first plate, and wherein the second plate comprises a plurality of transverse bores situated so that they align with the plurality of slots of the first plate.

9. The upper strut mount assembly of claim 8, wherein the second plate comprises stamped steel.

10. The upper strut mount assembly of claim 8, further comprising:
a plurality of studs, wherein each stud in the plurality of studs communicates with a transverse bore of the second plate and a corresponding slot of the first plate, wherein a head portion of each stud is retained by and mechanically coupled to the transverse bore, and wherein each stud includes a threaded portion for cooperating with a threaded nut, wherein when the threaded nut is tightened around the stud it contacts an upper surface of the first plate thereby securing the stud to the upper strut mount assembly.

11. The upper strut mount assembly of claim 1, further comprising:
an O-ring that circumferentially traverses an outer surface of the bottom portion of the cylindrical member.

12. The upper strut mount assembly of claim 1, further comprising:
an annular member comprising a central bore and a substantially identical diameter as a diameter of the second resilient member, wherein the annular member is configured to cooperate with a threaded nut member that communicates with an upper portion of a strut that passes through the central bore of the annular member, wherein when the threaded nut is tightened around the upper portion of the strut it contacts an upper surface of the annular member thereby retaining the strut to the upper strut mount assembly.

13. The upper strut mount assembly of claim 1, wherein the central bore of the cylindrical member is configured for accepting an upper portion of a strut.

14. The upper strut mount assembly of claim 1, wherein the first and second resilient members comprises urethane.

15. The upper strut mount assembly of claim 1, wherein the spring seat comprises billet aluminum.
